(19) United States
(12) Patent Application Publication
(10) Pub. No.: US 2003/0029254 A1
(43) Pub. Date: Feb. 13, 2003

(54) Blood analyzer

(76) Inventors: Kristian J. Hvidtfeldt, Virum (DK); Flemming Aas, Soborg (DK)

Correspondence Address: Kevin C. Hooper, Esq., BRYAN CAVE LLP, 245 Park Avenue, New York, NY, 10167-0034, US

(21) Appl. No.: 10/184,678

(22) Filed: Jun. 26, 2002

(30) Foreign Application Priority Data
Jun. 26, 2001 (DK) 2001/00995

(51) Int. Cl. G01N 1/16

(52) U.S. Cl. 73/863.33

(57) ABSTRACT

A blood analyzer has a sensor, a sample handler having a sample container station with a sample container bed adapted for holding a sample container, and a means for linearly moving a stirring element inside the sample container when the sample container is arranged in the sample container bed, and a means for transferring a sample from the sample container to the sensor. The blood analyzer is capable of stirring blood samples.

### FIELD OF THE INVENTION

The present invention relates to a blood analyzer.

### BACKGROUND OF THE INVENTION

The preanalytical phase of blood gas analyzis, i.e. the phase during which a blood sample is collected and stored, is the largest contributor of bias to the values obtained by the analyzis. For the patient incorrect and misleading values may be worse than no value at all.

Examples of biasing phenomena include coagulation, hemolysis, air bubbles, gas exchange, continued metabolism, and sample settling. The effects of these phenomena are minimized by shortening the preanalytical phase, by cooling of blood samples during storage, and by thorough stirring the blood sample before transfer thereof for analyzis.

The purpose of the stirring of samples is at least two-fold: It facilitates the dissolution of any anticoagulant, e.g. heparin, in the blood, and it prevents settling of the sample. Failure to properly dissolve the heparin may lead to formation of micro clots, which in turn can bias results and/or damage the analyzer. Settling may also lead to sample inhomogeneity and misleading analytical results.

Analyzers providing mixing means for series of blood samples are known in the prior art.

Wellerfors, U.S. Pat. No. 4,475,411 discloses an apparatus for taking a sample of blood or similar settling liquids from each of a plurality of containers. For sample preservation the containers are mounted along the periphery of a rotatable cassette and thus continuously mixed. Upon stopping the cassette rotation samples are collected from the containers.

Margrey et al., U.S. Pat. No. 5,366,896 discloses an integrated analytical system with a plurality of remote laboratories and a central monitoring station for the analyzis of, e.g., blood samples. The system includes a sample storage rack which is rotated to provide sample mixing.

Boyd et al., U.S. Pat. No. 5,959,221 discloses an apparatus for transporting racks of sealed blood sample-holding tubes, and mixing the samples upon driving the racks into a mixer channel in which the rack is rotated.

Rotation of sample containers, however, may be insufficient for proper mixing of blood samples, in particular of blood samples which have settled completely. Thus mixing by means of rotation is mainly performed on blood samples in sample containers with a gas volume which upon rotation is shifted in the container. For blood gas analysis, however, such mixing is detrimental to the sample as blood gas parameters are heavily biased. Therefore, when taking samples for blood gas analyzis it is attempted to exclude any gas volume in the sampler. The stirring of the samples is usually performed by means of manually moving a stirring element in the sample container. This is a well-known principle in the field of blood samplers.

White, U.S. Pat. No. 4,214,874 discloses a blood collection tube for mixing a blood sample and an anticoagulant by means of a magnetic element slidable within the tube. A magnet is moved manually along the tube for shifting the magnetic element. The tube is equipped with a cap with a cavity which may accommodate and hold the magnetic element by finger pressure to allow the element to be discarded with the cap prior to transfer of the sample to an analyzer.

Worley et al., U.S. Pat. No. 4,441,510 discloses a sampler for obtaining and processing blood scalp samples during fetal monitoring. The blood collection assembly employs a capillary tube coated with heparin on the inside and a metal flea inside the tube, which is moved by manually moving a magnet outside the tube.

Boyd et al., U.S. Pat. No. 5,227,138 discloses an apparatus for transportation of blood samples in a capillary tube. A magnet is manually moved to move a ferrous metal flea within the capillary tube to mix the blood sample and an anticoagulant chemical.

None of these references, however, teach automated blood analyzers for stirring a blood sample.

Thus, despite the hitherto proposed blood analyzers, there is still a need for a blood analyzer which provides proper mixing of a blood sample for blood gas analyzis, i.e. a blood sample in a completely filled sample container with no gas volume, and in which sample handling is automated.

### SUMMARY OF THE INVENTION

Accordingly, it would be advantageous to provide a blood analyzer for automatic handling of a blood sample or which has a sample handler having a sample container station with a sample container bed, and which provides proper stirring of a sample for blood analyzis.

One embodiment of the present invention is a blood analyzer comprising a sensor for measuring a parameter of a blood sample, a sample handler having a sample container station with a sample container bed adapted for holding a sample container, and a means for linearly moving a stirring element inside the sample container when the sample container is arranged in the sample container bed, and a means for transferring a sample from the sample container to the sensor.

Other embodiments of the present invention are blood analyzers having one or more of the following additional elements: an inlet module, a guide adjacent to the sample container bed, an adapter mount adapted to retain a sample container, a calibration container, a cooling element, a means for identification of the sample container, a means for moving the inlet module, and a display.

### BRIEF DESCRIPTION OF THE DRAWINGS

FIG. 1 shows a blood analyzer according to the present invention.

FIGS. 2a and 2b are diagrams showing a movable sample container station relative to a stationary magnetic field.

FIGS. 3a and 3b are diagrams showing a tiltable sample container station and a tiltable sample container bed, respectively.

FIG. 4 is a diagram showing an auxiliary inlet probe position and an auxiliary sample container position.

FIGS. 5a-d are diagrams illustrating the relative movements of the inlet module and the sample container station.

### DETAILED DESCRIPTION OF THE INVENTION

One embodiment of the present invention is a blood analyzer comprising a sensor for measuring a parameter of a blood sample, a sample handler having a sample container station with a sample container bed adapted for holding a sample container, and a means for linearly moving a stirring element inside the sample container when the sample container is arranged in the sample container bed, and a means for transferring a sample from the sample container to the sensor.

Other embodiments of the present invention are blood analyzers having one or more of the following additional elements: an inlet module, a guide adjacent to the sample container bed, an adapter mount adapted to retain a sample container, a calibration container, a cooling element, a means for identification of the sample container, a means for moving the inlet module, and a display.

As used herein, the term “blood analyzer” means a device for handling and analyzis of blood samples for determination of one or more parameters.

As used herein, the term “sample handler” means a device for handling and storage of samples. The sample handler may have means for preserving the samples, such as means for generating a magnetic field and cooling means, and it may have identification means.

As used herein, the term “sample container station” means the device holding the set of sample container beds in each of which a sample container may be arranged.

As used herein, the term “sample container bed” means a support onto which a sample container is positioned when arranged in the sample container station.

As used herein, the term “sensor” means any device for determination of desired information, e.g. a parameter, about a sample.

According to the invention the stirring element is moved linearly in the sample container. The linear movement is defined as a movement back and forth within the boundaries set by the sample container. It may include a spinning of a cylindrical stirring element around its longitudinal axis simultaneous with the movement along the longitudinal axis.

It should be understood, that the sample handler is preferably integral with the blood analyzer. Thus, upon integration of the sample handler with the blood analyzer sample handling and analyzis are facilitated as compact, easy-to-handle instruments are obtained. It should further be understood, that the sample container station is preferably integral with the sample handler, i.e. that the handler is designed so that the sample container station is a part thereof. Accordingly, the sample container remains in the sample container station during storage as well as during transfer of the sample to the sensor. Thus, upon integration of the sample container station with the sample handler sample handling is facilitated.

According to a preferred embodiment of the invention the sample containers are tubular sample containers. A tubular sample container is defined as a container the height of which is longer than any of the dimensions of its cross section, which may be round, elliptical, square, or rectangular. According to this preferred embodiment of the invention the linear movement of the stirring elements is a movement in the longitudinal direction of the tubular sample containers, which is defined as a one-dimensional movement of the stirring element in the direction of the height of the tubular sample container, i.e. in the direction perpendicular to the cross section.

The stirring element is preferably a cylindrical stirring element which, when located in a tubular sample container, may be moved along its longitudinal axis and may be spun around this axis, however, is restricted from rotation around any other axis. The cylindrical stirring element may be spiral, i.e. screw-shaped, to promote spinning and improve its stirring capacity. Alternatively, the stirring element may be spherical, cubical, box- or coin-shaped, or have any other shape which fits into the sample container cross section. The stirring element may also be pointed to fit into a syringe cone.

According to a preferred embodiment of the invention, the sample container station of the sample handler has a plurality of sample container beds, preferably 2-10 sample container beds, more preferably 3-5 sample container beds. Alternatively, the sample container station has 11-50 sample container beds, more preferably 20-50 sample container beds. Where the sample container station has a plurality of sample containers beds, the means for moving the stirring element is a means for moving one stirring element at a time or simultaneously the stirring elements in each of the sample containers. Accordingly, the elements may be moved in any combination or alone, i.e. one element out of five, two out of five, three out of five, four out of five or all five elements.

According to a preferred embodiment of the invention, the linear movement of the stirring element is achieved by the movement of a magnetic field and the sample container with the stirring element relative to each other. Such relative movement of the magnetic field and the sample container may be provided in at least three alternative ways: The magnetic field may move while the sample container is stationary, the sample container may move relative to a stationary magnetic field, or both the magnetic field and the sample container may move.

Thus, according to a preferred embodiment of the invention the means for moving the stirring element is a movable electromagnet or a moveable permanent magnet, preferably a movable permanent magnet, for the generation of an oscillating magnetic field relative to the sample container. According, in this preferred embodiment the magnetic field oscillates relative to the sample container, which is stationary. According to this embodiment the stirring element is a magnetic element, preferably a polymer body with embedded magnetic particles, e.g. a polypropylene body with embedded particles of ferritic stainless steel.

As used herein, the term “magnetic element” means an element, which is susceptible to a magnetic field as provided by e.g. a permanent magnet.

The permanent magnet or electromagnet are preferably provided in the sample handler adjacent to the sample container station.

Any pattern of movement of the magnetic field relative to the sample container which enables the linear movement of the stirring element in the sample container may be employed. Thus, in order to move linearly the stirring element in a tubular sample container by means of an oscillating magnetic field, the field should have a component oscillating in the longitudinal direction of the tubular sample container when arranged in the sample container bed. The magnetic field may thus oscillate in the longitudinal direction of the tubular sample container or it may oscillate in a direction deviating from the longitudinal direction of the tubular sample container, however, not perpendicular thereto. The oscillation frequency of the magnetic field is preferably in the 0.1-10 Hz range.

According to an alternative embodiment of the invention, the means for moving the stirring element is a stationary electromagnet or a stationary permanent magnet, preferably a stationary permanent magnet, for generation of a stationary magnetic field and a sample container station, movable relative to the stationary magnetic field. According to this embodiment, the stirring element is a magnetic element, preferably a polymer body with embedded magnetic particles, e.g. a polypropylene body with embedded particles of ferritic stainless steel.

Preferably the sample container station moves linearly or rotates relative to the stationary magnetic field.

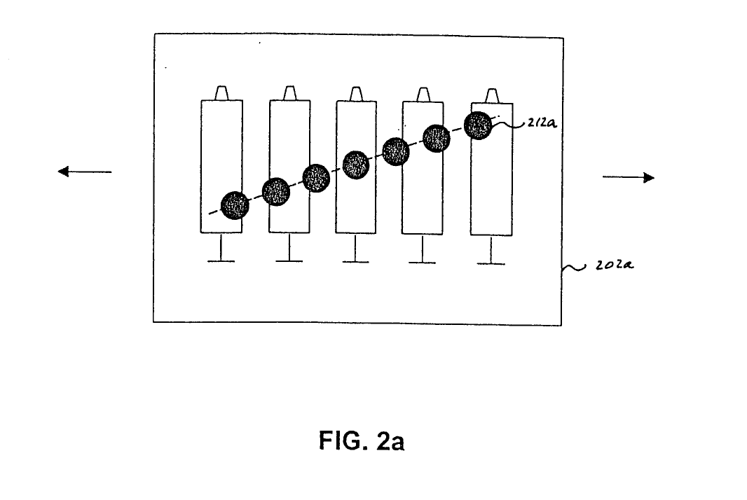

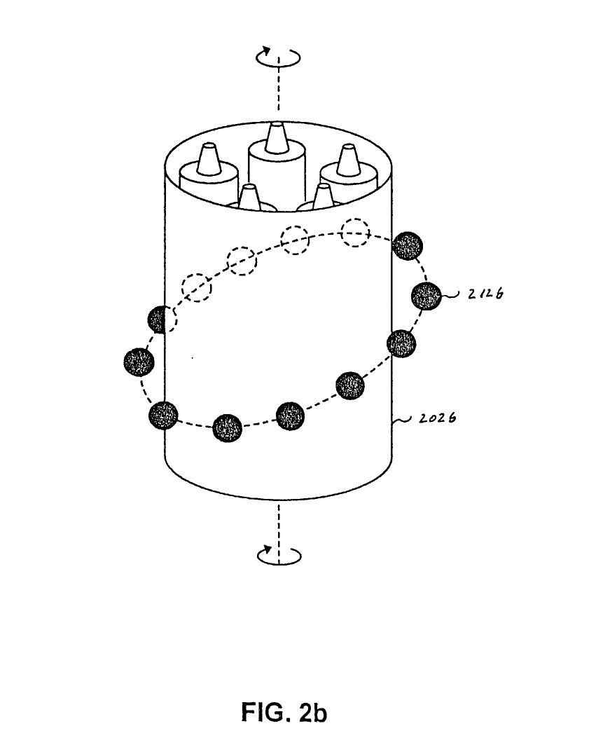

The linear movement of the sample container station relative to the stationary magnetic field is preferably accomplished by an arrangement as shown in FIG. 2a, in which the sample container station is arranged in one plane and a stationary magnet is arranged in a second plane, parallel to the first plane, the stationary magnet being further arranged so that its projection on the longitudinal axis of the sample container when arranged in the sample container station covers at least 80% of the full length of the sample container, and in which the sample container station may be moved in its plane, perpendicular to the longitudinal axis of the sample container.

Thus, upon displacement of the sample container station the stirring element of the sample container will be moved back and forth within the sample container. The displacement of the sample container should reach as far as to allow the stirring elements to be moved along at least 80% of the full length of the sample container.

The rotation of the sample container station relative to a stationary magnetic field is preferably accomplished by an arrangement as shown in FIG. 2b, in which the sample container station is a carrousel with a centre axis arranged within an encircling stationary magnet, the stationary magnet being further arranged so that its projection on the longitudinal axis of the sample container when arranged in the sample container station covers at least 80% of the full length of the sample container, and in which the sample container station may be rotated around its centre axis.

Thus, upon rotation of the carrousel the stirring element in the sample container is moved back and forth within the sample container. The rotation of the sample container should be complete to allow the stirring elements to be moved along at least 80% of the full length of the sample container.

According to another preferred embodiment of the invention the sample container station and/or the individual sample container beds are movable, preferably tiltable.

Thus, according to the embodiment in which the sample container station is movable, the entire sample container station is moved, preferably tilted, whereby the stirring element in the sample container is moved linearly therein. According to this embodiment the stirring element may be non-magnetic. The means for tilting the sample container station is preferably an electric motor connected to the sample container station via a lever.

In order to move linearly the stirring element in the sample container by means of movements of the entire sample container station, the movement should have a component in the vertical axial plane of the sample container. Thus, the sample container station may perform a movement, preferably a tilting, in the vertical axial plane of the sample container or alternatively perform a movement, preferably a tilting, which has a component in the vertical axial plane of the sample container.

According to the embodiment in which the sample container bed is movable, the container bed is moved, preferably tilted, relative to the sample container station, whereby the stirring element in the sample container is moved linearly. According to this embodiment of the invention the stirring element may be non-magnetic. The means for tilting the sample container bed is preferably an electric motor connected to the sample container bed via a lever.

In order to move linearly the stirring element in the sample container by means of movements of the sample container bed, the movement has a component in the vertical axial plane of the sample container. Thus, the sample container bed may perform a movement, preferably a tilting, in the vertical axial plane of the sample container or alternatively perform a movement, preferably a tilting, which has a component in the vertical axial plane of the sample container.

The blood analyzer according to the invention has a means for transferring a sample from the sample container to the sensor. The means for transferring the sample preferably comprises an inlet probe, more preferably an aspiration inlet probe, for collecting a liquid sample from the sample container when arranged in the sample container bed and transferring the sample to the sensor.

As used herein, the term “inlet probe” means a tubular item through which a sample may be transferred from a sample container to the sensor. The inlet probe may also be referred to as an inlet tube, or a suction probe. The inlet probe may be provided in an inlet module.

As used herein, the term “inlet module” means a structure holding the inlet probe and defining positions for the inlet probe to be arranged in. The inlet module may further comprise tubing and/or means for operating the inlet probe. Alternatively such tubing and operating means are connected to the inlet module.

According to this preferred embodiment, the inlet probe may be an aspiration probe, by means of which a sample is aspirated via the inlet probe from the sample container for subsequent transfer to the sensor. The aspiration probe is operated by means of a subatmospheric pressure, which may be provided by means of a vacuum pump. The amount of sample aspirated is monitored by means of one or more liquid sensors within the tubing of the inlet module.

According to a preferred embodiment of the invention, the means for moving the stirring element is the inlet probe. Thus, according to this embodiment, the movement of the stirring element is provided by a movement of the inlet probe within the sample in the sample container. By mechanically or magnetically coupling the inlet probe to the stirring element, the stirring element may be moved with the inlet probe. The coupling may be accomplished by means of a holding and release means by which the stirring element during stirring is held by the inlet probe, and, upon completion of the stirring, released.

Thus, according to a further preferred embodiment of the invention, the stirring element has a female shape to mate with the tip of the inlet probe, preferably by means of a snap fit. According to this embodiment the stirring element is preferably made from a polymer like polypropylene or polyethylene, and preferably it carries heparin.

According to another further preferred embodiment of the invention, the sample container is a syringe with a syringe plunger, and the stirring element is a releasable part of the plunger. Thus the stirring element is provided as an integral part of the plunger from which it is released upon coupling with the inlet probe.

According to an alternative preferred embodiment of the invention, the coupling between the stirring element and the inlet probe is provided by means of the inlet probe being an electromagnet and the stirring element being magnetic.

According to a preferred embodiment of the invention, the inlet probe is provided in the inlet module which defines a number of inlet probe positions corresponding to the number of sample container beds. From each inlet probe position the inlet probe may collect a sample from the sample container arranged in the sample container bed corresponding to said inlet probe position.

According to another preferred embodiment of the invention, the inlet module defines an auxiliary inlet probe position from which the inlet probe may collect a sample from the sample container when arranged in an auxiliary sample container position.

The auxiliary inlet probe position is an additional inlet probe position to which there is no corresponding sample container bed in the sample container station. However, the auxiliary sample container position is a separate sample container position arranged adjacent to the sample container station.

The combination of the auxiliary inlet probe position and the auxiliary sample container position makes up an “emergency inlet”, which may be used for immediate transfer of the sample from the sample container to the sensor. Accordingly the sample may be transferred to the sensor prior to a sample from a sample container arranged in the sample container station. Thus, the auxiliary sample container position does not include a sample container bed and does not include a stirring means.

According to a preferred embodiment of the invention, the sample handler has a guide, preferably a cone or a cone bearing, arranged adjacent to a sample container bed, to facilitate connection of the sample container to the inlet module. The guide may contain one or more airtight seal to facilitate below or above pressure operation. Preferably the sample handler comprises a guide for every sample container bed.

According to another preferred embodiment of the invention, the sample container bed has an adapter mount, for retaining a sample container equipped with an adapter in the sample container bed. The adapter mount preferably comprises a saddle for receiving an adapter of a corresponding shape.

The adapter mount is preferably keyed to receive a sample container equipped with a correspondingly keyed adapter. Such keyed adapter mount-adapter combinations may be used for identification purposes and thus facilitate the proper allocation of measurement results. Preferably each of the sample container beds of the sample container station comprises an adapter mount.

According to a preferred embodiment of the invention, the inlet module has a quality control inlet probe position for collecting a quality control solution from a quality control solution container arranged in a quality control solution station. The quality control solution container is preferably an ampoule, a pouch, or a bag.

According to another preferred embodiment of the invention, the inlet module has a calibration inlet probe position for collecting a calibration solution from a calibration solution container arranged in a calibration solution station. The calibration solution container is preferably an ampoule, a pouch or a bag.

The sample handler preferably includes rinsing and/or cleaning means for rinsing and/or cleaning the inlet module and the sensor. According to this embodiment of the invention it should be understood, that the rinsing procedure is typically repeated after each measurement, whereas the cleaning procedure is repeated less frequently, e.g. after analyzing a sample with a high lipid content.

Syringes are the most common type of sample container, i.e. sampler, for blood sampling. For sampling of arterial blood, which is the preferred form of blood for blood gas analyzis, self-filling syringes are preferably used. Such self-filling syringes are filled by means of the arterial blood pressure while the air in the syringe is expelled via a filter which blocks upon exposure to liquid, i.e. when the syringe is filled with sampled blood. In other cases, e.g., for sampling of fetal or neonatal blood, capillary tubes with a very small volume are used for sampling of scalp or heel blood. Test tubes may be used for blood sampling as well.

Thus, according to a preferred embodiment of the invention the sample container is a syringe, a capillary tube, or a test tube.

In a preferred embodiment of the invention, the sample container bed is positioned such that the longitudinal axis of the sample container is horizontal to the ground when in the sample container bed. According to this embodiment of the invention capillary tubes are less likely to leak when arranged horizontally, and thus capillary tubes are preferably arranged in sample container beds which are horizontally positioned.

In another preferred embodiment of the invention, the sample container bed is inclined, preferably by an angle in the range 10-90° relative to horizontal, more preferably by an angle in the range 10-30° relative to horizontal, even more preferably by an angle in the range 15-25° relative to horizontal. Thus, the sample container arranged in the sample container bed is inclined arranged in accordance hereto. According to this embodiment of the invention, the inclined arrangement of syringes facilitates the accumulation of the air bubbles left in a syringe as well as the collection of the full syringe volume. Further, syringes are less likely to leak when arranged inclined, and thus syringes are preferably arranged in sample container beds which are inclined positioned.

In a preferred embodiment of the invention, the sample handler further comprises a cooling element, preferably a Peltier-element, situated adjacent to the sample container station.

According to a preferred embodiment of the invention, the sample handler has an identification means for identification of the sample container when arranged in the sample container bed. Preferably the identification means has a sample handler reading means for reading identification data stored in a sample container memory means.

Sample identification data may include patient ID as well as sampling date, time and site, type of sample, patient temperature and ventilator settings. Based on the patients temperature the blood analyzer may display temperature corrected results.

In a preferred embodiment of the invention, the sample container memory means is a bar code, preferably a preprinted bar code which is programmed at a point-of-care, and the sample handler reading means is a bar code reader. Preferably the bar code reader is integrated with the sample handler to allow reading of the sample container bar code when the sample container is arranged in the sample container bed.

Alternatively, the sample container memory means comprise more sophisticated electronic memory means such as ROMs, RAMs, PROMs, EPROMs, E²PROMs, magnetic strips, or optically readable memory means. Accordingly, the sample handler reading means is reading means corresponding to the memory means.

According to a preferred embodiment of the invention, the blood analyzer has a means for moving the inlet module relative to the sample container station. It is preferred that the means for moving the inlet module relative to the sample container station is a means for moving the inlet module and/or a means for moving the sample container station, preferably a means for moving the sample inlet module relative to a stationary sample container station.

The movement of the inlet module is defined as a movement of the inlet module between each of inlet probe positions. The movement of the inlet module may be a linear movement or a circular movement, i.e. a rotation. On movement of the sample container station the set of sample container beds making up the sample container station is shifted relative to the inlet module. The movement of the sample container station may be a linear movement or it may be a circular movement, i.e. a rotation.

According to a preferred embodiment of the invention, the means for moving the inlet module relative to the sample container station may be an electric motor, which, via a gear, provides the movement of the inlet module and/or the sample container station.

According to a preferred embodiment of the invention, the analyzer has a display adapted to display any status and identification data of the currently analyzed sample, of the current analyzis, and of the current collection sequence.

All of the sample container beds are preferably numbered and their numbers displayed.

The display preferably comprises a touch screen for operating the analyzer. Thus the desired mode of analyzis, collection sequence, mixing pattern etc. may be selected via the touch screen.

Preferably the sensor is selected from the group consisting of a blood gas sensor, a blood electrolyte sensor, a blood metabolite sensor, a blood coagulation sensor, a heart enzyme sensor, and combinations thereof.

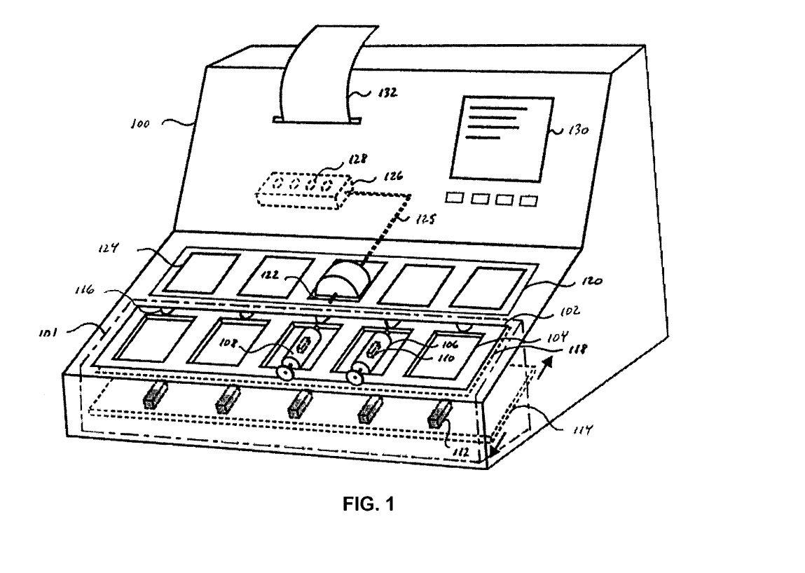

FIG. 1 shows a preferred embodiment of the present invention in which the blood analyzer (100) comprises a sample handler (101) having a sampler container station (102) with five separate sample container beds (104). Each of the five sample container beds (104) is adapted to accomodate a syringe (106) holding a blood sample (108) and a stirring element (110), which is magnetic.

As part of the sample handler (101), and situated below the sample container beds (104) are five permanent magnets (112) arranged on a movable magnet board (114). Thus the stirring elements (110) in the syringes (106) will be moved on movement of the magnet board (114).

The stirring pattern is programmable in terms of stirring frequency, amplitude, and intervals.

To facilitate accomodation, each of the syringes (106) are equipped with an adapter (not shown), which fits onto the luer of the syringes, and which is shaped to fit into a mount (116) of the sample container bed (104).

During storage, the syringe (106) is cooled by means of a Peltier-element (118) which is part of the sample handler (101) and situated below the sample container station (102). Thus, during storage, the sample (108) in the syringe (106) arranged in the sample container bed (104) is cooled to a temperature of about 0-10° C. to slow down continued metabolism in the blood sample (108), and thus allow a proper preservation of the blood.

An inlet module (120) of the blood analyzer (100) has an inlet probe (122), which may be arranged in five separate inlet probe positions (124), each position corresponding to one of the five sample container beds (104).

For sample collection, the inlet probe (122) is extended into the syringes (106) to aspirate a blood sample (108) for subsequent transfer via the tubing (125) to a sensor (128) arranged in a sensor block (126).

In a preferred embodiment of the invention the inlet probe (122) collects sample from a plurality of positions within the blood contained in the syringe (106), e.g. the inlet probe (122) collects a part of the sample from the top of the blood volume and a part of the sample from the bottom of the blood volume.

The blood samples (108) are collected from the syringes (106) in the sample container beds (104) according to a predetermined collection sequence. Examples of such collection sequences are:

(a) A chronological sequence according to which the time of receipt of the syringe in the sample handler is recorded and in which the collection sequence is a chronologically ordered sequence, so that a sample is collected from the oldest syringe.

(b) An alternative chronological sequence according to which the time of sampling from the patient is recorded and in which the collection sequence is a chronologically ordered sequence, so that a sample is collected from the syringe which carries the oldest sample.

(c) A numerical sequence according to which the sample container beds are numbered, in which the syringes are numbered in accordance hereto, and in which the collection sequence is a numerically ordered sequence. Thus, subsequent to collection of a sample from the highest numbered syringe the sequence is repeated, i.e. a sample from the lowest numbered syringe is collected and then from the next lowest number etc.

(d) A prioritized numerical sequence according to which the sample container beds are numbered, in which the syringes are numbered in accordance hereto and in which the collection sequence is so ordered that at any time a sample is collected from the syringe arranged in the sample container bed with the lowest number.

(e) A “non-rejection” sequence according to which the time of receipt of the syringe in the sample handler is recorded and in which syringes from which samples are not collected within a predetermined time after the time of receipt are prioritised.

(f) An alternative “non-rejection” sequence according to which the time of sampling from the patient is recorded and in which syringes from which samples have not been collected within a predetermined time after the time of sampling are prioritised.

(g) A “rejection” sequence according to which the time of receipt of the samples in the sample handler or the time of sampling is recorded, and according to which samples which have not been collected within a predetermined time range from the time of receipt or of sampling are rejected.

Stirring is paused during sample collection via the inlet probe.

Status and identification data of the currently analyzed sample, the current analyzis, and the current collection sequence are displayed by a display (130). Subsequently the measurement results are displayed by the display (130) and printed to the operator by a printer (132).

The completion of sample collection from the syringe is displayed to inform the operator that the sample container can be removed. An alarm is activated in case a syringe is removed before a sample has been collected therefrom.

With reference to FIGS. 2a and 2b the principle of a movable sample container station relative to a stationary magnetic field is illustrated diagrammatically. Thus FIG. 2a shows a planar sample container station (202a) linearly movable relative to a stationary planar magnet (212a). By moving the sample container station (202a) the stirring elements (not shown) in the syringes held in the sample container station are moved back and forth. FIG. 2b shows a cylindrical sample container station (202b) which is rotatable within a stationary encircling magnet (212b). By rotation of the sample container station (202b) the stirring elements (not shown) in the syringes held in the sample container station are moved back and forth.

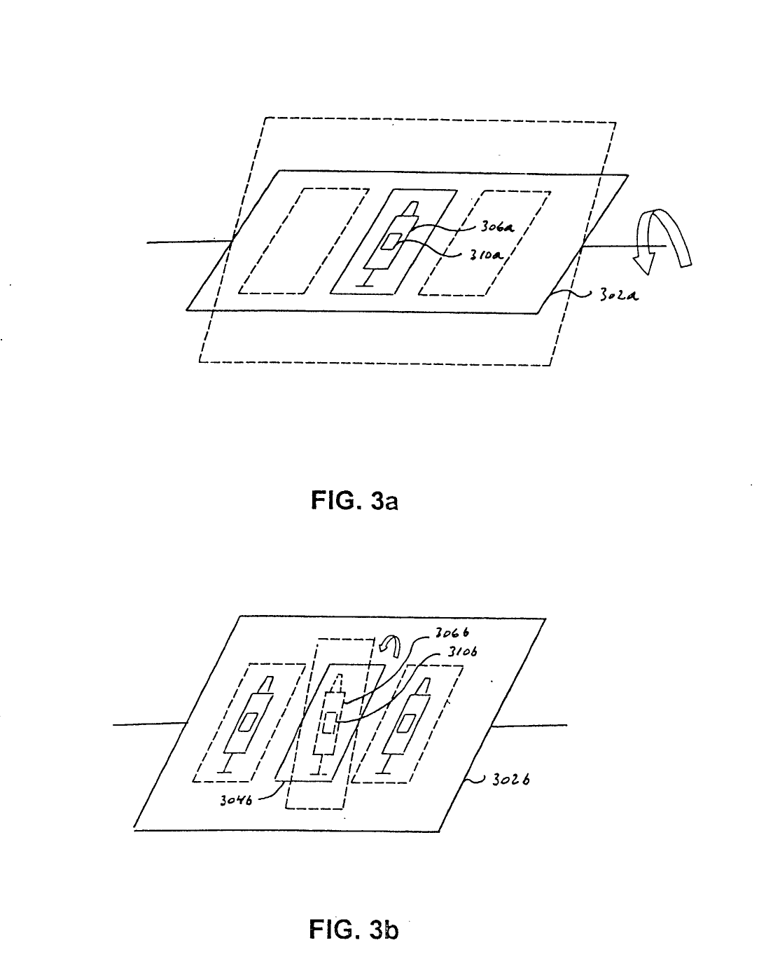

FIGS. 3a and 3b show a tiltable sample container station and a tiltable sample container bed. Thus FIG. 3a shows a tiltable sample container station (302a), which, when tilted, induces the movement of the stirring element (310a) in the syringes (306a) arranged in the sample container station (302a) by means of gravity. It should be understood that all of the syringes held in the sample container station are stirred simultaneously upon tilting of the sample container station (302a), and that for sample collection, the sample container station (302a) is returned to its basic position.

FIG. 3b shows a sample container station (302b) with a tiltable sample container bed (304b), which, when tilted, induces the movement of the stirring element (310b) in the syringe (306b) held in the sample container bed (304b) by means of gravity. It should be understood, that only the syringe (306b) arranged in the sample container bed (304b) is tilted, and that for sample collection, the sample container bed (304b) is returned to its basic position.

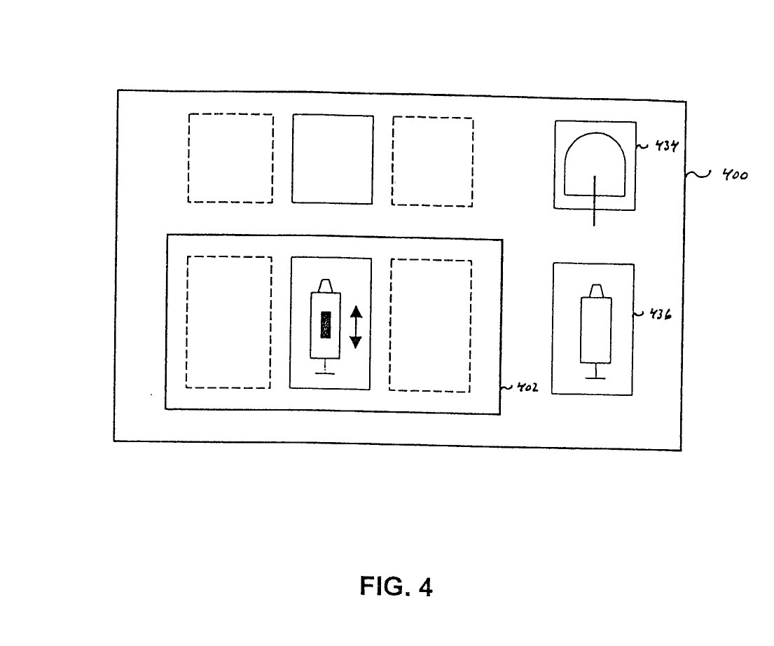

FIG. 4 shows a diagram of a handler (400) having an auxiliary inlet probe position (434) and an auxiliary sample container position (436). Those two positions make up an “emergency inlet”, which may be used for urgent measurements.

Corresponding to the “emergency inlet” is an “emergency” collection sequence according to which a sample from a syringe in the auxiliary sample container position (436) is collected via the inlet probe in the auxiliary inlet probe position (434), prior to collection of samples from any other syringe arranged in the sample container station (402). According to the “emergency sequence” the priority of any on-going analyzis is obeyed in order not to destroy the analyzis and results thereof.

Upon completion of sample collection from the syringe in the auxiliary sample container position the syringe is removed.

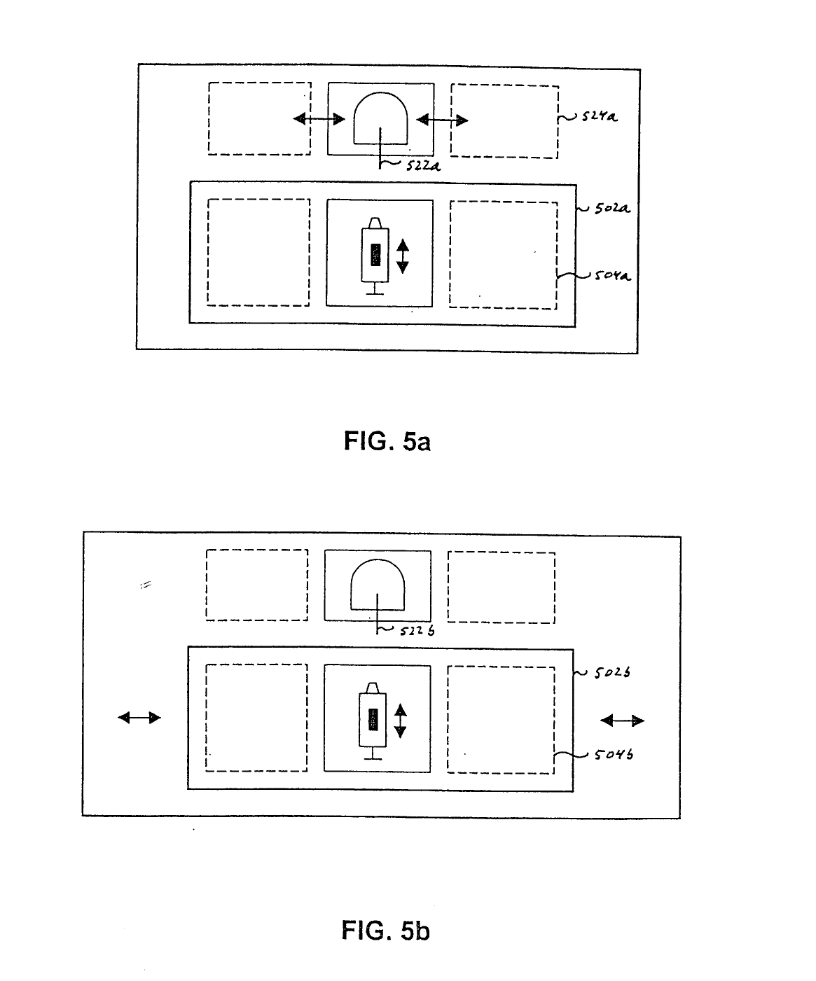

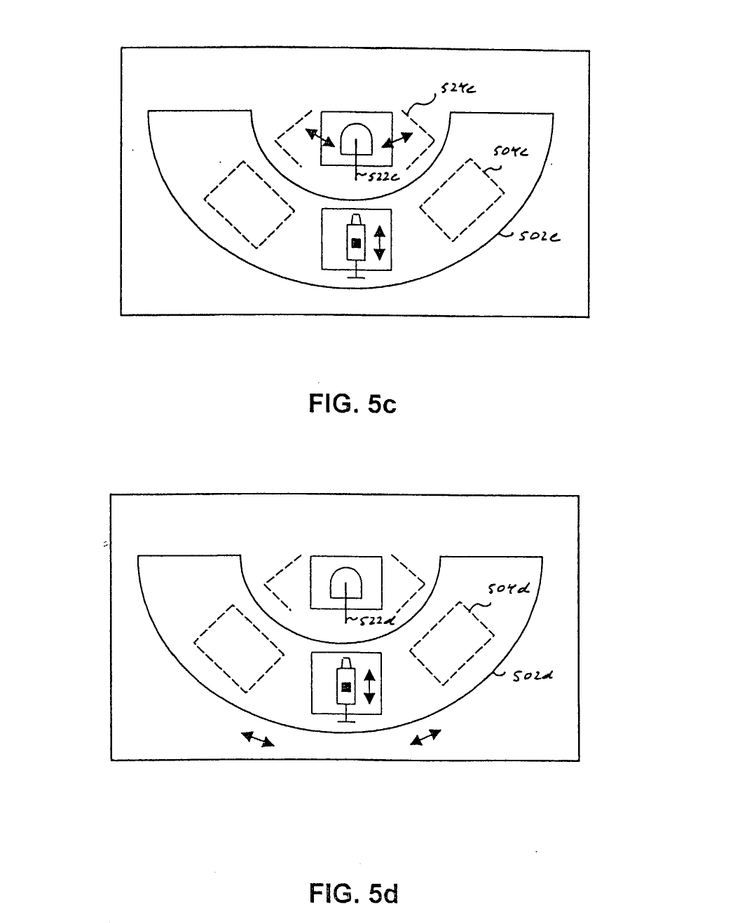

FIGS. 5a-5d show diagrammatically of the movement of the inlet module and the sample container station, relative to each other.

FIG. 5a shows the linear movement of an inlet probe (522a) between three inlet probe positions (524a), corresponding to three sample container beds (504a) of a sample container station (502a).

FIG. 5b shows the linear movement of a sample container station (502b) to allow each of three sample container beds (504b) to be arranged in correspondence with an inlet probe (522b).

FIG. 5c shows the rotational movement of an inlet probe (522c) between three inlet probe positions (524c), corresponding to three sample container beds (504c) of a sample container station (502c).

FIG. 5d shows the rotational movement of a sample container station (502d) to allow each of three sample container beds (504d) to be arranged in correspondence with an inlet probe (522d).

What is claimed is:

1. A blood analyzer comprising:
a sensor for measuring a parameter of a blood sample,
a sample handler having a sample container station with a sample container bed adapted for holding a sample container containing a stirring element, and a means for moving linearly the stirring element in the sample container when the sample container is arranged in the sample container bed, and
a means for transferring a sample from the sample container to the sensor.

2. A blood analyzer according to claim 1 in which the sample container station comprises a plurality of sample container beds for holding a plurality of sample containers each containing a stirring element, and wherein the means for moving the stirring element can move at least one stirring element independently of another stirring element.

3. A blood analyzer according to claim 2 having from 2 to 10 sample container beds.

4. A blood analyzer according to claim 2 having from 3 to 5 sample container beds.

5. A blood analyzer according to claim 1 in which the sample container station comprises a plurality of sample container beds for holding a plurality of sample containers each containing a stirring element, and wherein the means for moving the stirring element can move the stirring elements simultaneously.

6. A blood analyzer according to claim 5 having from 2 to 10 sample container beds.

7. A blood analyzer according to claim 5 having from 3 to 5 sample container beds.

8. A blood analyzer according to claim 1 wherein the means for linearly moving the stirring element is a movable magnet, and wherein the stirring element is a magnetic element.

9. A blood analyzer according to claim 8 wherein the movable magnet is an electromagnet or a permanent magnet.

10. A blood analyzer according to claim 1 wherein the means for linearly moving the stirring element comprises a stationary magnet and a movable sample container station, and wherein the stirring element is a magnetic element.

11. A blood analyzer according to claim 10 wherein the stationary magnet is an electromagnet or a permanent magnet.

12. A blood analyzer according to claim 10 wherein the sample container station is arranged in one plane and the stationary magnet is arranged in a second plane parallel to the first plane such that magnet's projection on the longitudinal axis of the sample container when arranged in the sample container station covers at least 80% of the full length of the sample container, and wherein the sample container station may be moved in the first plane in a direction perpendicular to the longitudinal axis of the sample container.

13. A blood analyzer according to claim 10 wherein the sample container station is a carrousel having a centre axis, the carrousel is encircled by the stationary magnet such that the projection of the stationary magnet on the longitudinal axis of the sample container when arranged in the sample container station covers at least 80% of the full length of the sample container, and wherein the sample container station is adapted to rotate around its center axis.

14. A blood analyzer according to claim 1 wherein the sample container station and/or the sample container bed are movable.

15. A blood analyzer according to claim 14 wherein the sample container station and/or the sample container bed are tiltable.

16. A blood analyzer according to claim 1 wherein the means for transferring a sample from the sample container to the sensor comprises an inlet probe, adapted to collect a liquid sample from the sample container when arranged in the sample container bed.

17. A blood analyzer according to claim 16 wherein the inlet probe is an aspiration inlet probe.

18. A blood analyzer according to claim 16 wherein the means for linearly moving the stirring element is the inlet probe.

19. A blood analyzer according to claim 16 wherein the inlet probe is arranged in an inlet module having a number of inlet probe positions corresponding to the number of sampler container beds and such that when the inlet probe is arranged in one of the inlet probe positions the inlet probe is capable of collecting a sample from a sample container arranged in the corresponding sample container bed.

20. A blood analyzer according to claim 19 wherein the inlet module has an auxiliary inlet probe position such that when the inlet probe is arranged in the auxiliary inlet probe position the inlet probe is capable of collecting a sample from a sample container arranged in an auxiliary sample container position.

21. A blood analyzer according to claim 19 wherein the sample handler has a guide arranged adjacent to the sample container bed, and adapted to facilitate the alignment and connection of the sample container to the inlet module.

22. A blood analyzer according to claim 21 wherein the guide is a cone or a cone bearing.

23. A blood analyzer according to claim 1 wherein the sample container bed has an adapter mount adapted to retain a sample container equipped with an adapter in the sample container bed.

24. A blood analyzer according to claim 23 wherein the adapter mount is keyed to receive a sample container equipped with a correspondingly keyed adapter.

25. A blood analyzer according to claim 19 further comprising a quality control solution container, and wherein the inlet module has a quality control inlet probe position such that when the inlet probe is arranged in the quality control inlet probe position the inlet probe is capable of collecting a quality control solution from the quality control solution container arranged in a quality control container position.

26. A blood analyzer according to claim 19 further comprising a calibration solution container, and wherein the inlet module has a calibration inlet probe position such that when the inlet probe is arranged in the calibration inlet probe position the inlet probe is capable of collecting a calibration solution from the calibration solution container arranged in a calibration container position.

27. A blood analyzer according to claim 1 wherein the sample container is selected from the group consisting of a syringe, a capillary tube, and a test tube.

28. A blood analyzer according to claim 1 wherein the sample container bed is positioned such that the longitudinal axis of the sample container arranged in the sample container bed is horizontal to the ground.

29. A blood analyzer according to claim 1 wherein the sample container bed is positioned such that the longitudinal axis of the sample container arranged in the sample container bed is at an angle from about 10 degrees to about 90 degrees from an axis horizontal to the ground.

30. A blood analyzer according to claim 29 wherein the sample container bed is positioned such that the longitudinal axis of the sample container arranged in the sample container bed is at an angle from about 10 degrees to about 30 degrees from an axis horizontal to the ground.

31. A blood analyzer according to claim 30 wherein the sample container bed is positioned such that the longitudinal axis of the sample container arranged in the sample container bed is at an angle from about 15 degrees to about 25 degrees from an axis horizontal to the ground.

32. A blood analyzer according to claim 1 further comprising a cooling element adjacent to the sample container bed.

33. A blood analyzer according to claim 32 wherein the cooling elements is a Peltier-element.

34. A blood analyzer according to claim 1 wherein the sample handler comprises a means for identification of the sample container when arranged in the sample container bed.

35. A blood analyzer according to claim 34 wherein the means for identification comprises a sample container memory means, and a sample handler reading means for reading data stored in the sample container memory means.

36. A blood analyzer according to claim 19 further comprising a means for moving the inlet module relative to the sample container station.

37. A blood analyzer according to claim 36 wherein the means for moving the inlet module relative to the sample container station is a means for moving the inlet module relative to a stationary sample container station.

38. A blood analyzer according to claim 1 wherein the sensor is selected from the group consisting of a blood gas sensor, a blood electrolyte sensor, a blood metabolite sensor, a blood coagulation sensor, a heart enzyme sensor, and combinations thereof.

39. A blood analyzer according to claim 34 further comprising a display adapted to display status and identification data of the sample being analyzed, the current analyzis, and the current collection sequence.

40. A blood analyzer according to claim 39 wherein the display is a touch screen adapted to operate the analyzer.
